(19) United States
(12) Patent Application Publication
(10) Pub. No.: US 2024/0199958 A1
(43) Pub. Date: Jun. 20, 2024

(54) MANUFACTURING OF HIGH-PERFORMANCE INTUMESCENT FLAME-RETARDANT POLYMERS

(71) Applicant: The Texas A&M University System, College Station, TX (US)

(72) Inventors: Qingsheng Wang, College Station, TX (US); Ruiqing Shen, College Station, TX (US); Yufeng Quan, College Station, TX (US)

(73) Assignee: The Texas A&M University System, College Station, TX (US)

(21) Appl. No.: 18/288,941

(22) PCT Filed: Apr. 28, 2022
(86) PCT No.: PCT/US2022/026820

§ 371 Date: Oct. 30, 2023

Related U.S. Application Data
(60) Provisional application No. 63/182,619, filed on Apr. 30, 2021.

(51) Int. Cl. C09K 21/06; B01J 31/16; C08K 5/053; C08K 5/52; C09K 21/02; C09K 21/12

(52) U.S. Cl. CPC C09K 21/06; B01J 31/1691; C08K 5/053; C08K 5/5205; C09K 21/02; C09K 21/12

(57) ABSTRACT

In an embodiment, the present disclosure pertains to a flame-retardant composite composed of a polymer, an intumescent flame retardant (IFR), and a metal-organic framework (MOF). In some embodiments, the MOF is a zeolitic imidazolate framework (ZIF). In some embodiments, the MOF is a bimetallic MOF. In some embodiments, the bimetallic MOF is a bimetal ZIF. In an additional embodiment, the present disclosure pertains to a flame-retardant composite composed of a polymer that can include, without limitation, polypropylene, polyethylene, high-density polyethylene, low-density polyethylene, polystyrene, polyvinyl chloride, poly(methyl methacrylate), a polyolefin, and combinations thereof, an IFR, and a ZIF.

### CROSS-REFERENCE TO RELATED APPLICATIONS

This patent application claims priority from, and incorporates by reference the entire disclosure of, U.S. Provisional Application 63/182,619 filed on Apr. 30, 2021.

### TECHNICAL FIELD

The present disclosure relates generally to flame-retardant polymers and more particularly, but not by way of limitation, to manufacturing of high-performance intumescent flame-retardant polymers.

### BACKGROUND

This section provides background information to facilitate a better understanding of the various aspects of the disclosure. It should be understood that the statements in this section of this document are to be read in this light, and not as admissions of prior art.

In general, commodity plastics and/or polymers are very flammable. Current commercialized flame retardants for commodity plastics and/or polymers, such as, but not limited to, polypropylene, are not sufficient enough for suppressing heat release and toxic gases during combustion. Current commercial intumescent flame-retardants generally have a low dispersion efficiency within the polymer matrix, and therefore, they cannot form a compact and stable char residue during polymer combustion. Additionally, they usually have high smoke production rates (e.g., carbon monoxide) causing high level of toxicity during combustion. Moreover, current intumescent flame-retardant composites require high loading to reach good performance, which compromises the mechanical strength of the polymer composites due to the weak interfacial compatibility. Furthermore, a large amount of filler is not cost-effective for manufacturing and production.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In an embodiment, the present disclosure pertains to a flame-retardant composite composed of a polymer, an intumescent flame retardant (IFR), and a metal-organic framework (MOF).

In some embodiments, the polymer can include, without limitation, polypropylene, polyethylene, high-density polyethylene, low-density polyethylene, polystyrene, polyvinyl chloride, poly(methyl methacrylate), a polyolefin, and combinations thereof. In some embodiments, the polymer is polypropylene (PP).

In some embodiments, the flame-retardant composite has a structure contributing to flame-retardant properties. In some embodiments, the flame-retardant composite has synergistic activity between the MOF and the IFR to contribute to flame-retardant properties.

In some embodiments, the MOF is a zeolitic imidazolate framework (ZIF). In some embodiments, the ZIF has synergistic interactions with the IFR and promotes cross-linking reactions in a condensed phase for a carbonaceous physical barrier to form a compact and continuous char structure. In some embodiments, the ZIF can include, without limitation, ZIF-8, ZIF-67, ZIF-8 synthesized at room temperature (ZIF-8-RT), ZIF-8 synthesized at 40° C. (ZIF-8-40C), and combinations thereof.

In some embodiments, the MOF is a bimetallic MOF. In some embodiments, the bimetallic MOF is a bimetal ZIF. In some embodiments, the bimetal ZIF has two metals that can each include, without limitation, transition metals, iron, zinc, cobalt, nickel, copper, and combinations thereof. In some embodiments, the two metals are zinc and cobalt. In some embodiments, the bimetal ZIF is ZnCoZIF.

In some embodiments, the IFR has at least one of an acid, a carbon agent, a blowing agent, or combinations thereof. In some embodiments, the IFR is composed of at least one of ammonium polyphosphate (APP), melamine polyphosphate (MPP), pyrophosphate (PyMP), or combinations thereof. In some embodiments, the IFR is composed of at least one of pentaerythritol (PER), a biomass lignin, or combinations thereof. In some embodiments, the IFR is composed of APP and PER. In some embodiments, the APP and PER have a mass ratio of 3:1.

In some embodiments, the MOF has a size less than 1000 nm. In some embodiments, the MOF has a size in a range between 100 nm to 1000 nm. In some embodiments, the MOF has a size in a range between 200 nm to 300 nm. In some embodiments, the MOF has a size in a range between 100 nm to 250 nm.

In some embodiments, the polymer is PP, the IFR includes APP and PER with a mass ratio of 3:1, and the MOF includes ZIF-8 in an amount of 2 wt % of the flame-retardant composite. In some embodiments, the ZIF-8 has a size of 100 nm. In some embodiments, the ZIF-8 has a size of 250 nm. In some embodiments, the ZIF-8 has a size of 1000 nm. In some embodiments, the MOF includes a ZIF in an amount between 1 wt % to 2 wt % of the flame-retardant composite.

In some embodiments, the flame-retardant composite has a limiting oxygen index (LOI) greater than 28%. In some embodiments, the flame-retardant composite has a Standard for Safety of Flammability of Plastic Materials for Parts in Devices and Appliances (UL-94) rating of V-0.

In an additional embodiment, the present disclosure pertains to a flame-retardant composite composed of a polymer that can include, without limitation, polypropylene, polyethylene, high-density polyethylene, low-density polyethylene, polystyrene, polyvinyl chloride, poly(methyl methacrylate), a polyolefin, and combinations thereof, an intumescent flame retardant (IFR), and a zeolitic imidazolate framework (ZIF).

In some embodiments, the polymer is polypropylene (PP). In some embodiments, the ZIF has synergistic interactions with the IFR and promotes cross-linking reactions in a condensed phase for a carbonaceous physical barrier to form a compact and continuous char structure.

In some embodiments, the ZIF can include, without limitation, ZIF-8, ZIF-67, ZIF-8 synthesized at room temperature (ZIF-8-RT), ZIF-8 synthesized at 40° C.(ZIF-8-40C), and combinations thereof. In some embodiments, the ZIF is a bimetallic ZIF. In some embodiments, the bimetal ZIF includes two metals that can include, without limitation, transition metals, iron, zinc, cobalt, nickel, copper, and combinations thereof. In some embodiments, the two metals are zinc and cobalt. In some embodiments, the bimetal ZIF is ZnCoZIF.

In some embodiments, the IFR includes at least one of an acid, a carbon agent, a blowing agent, or combinations thereof. In some embodiments, the IFR includes at least one of ammonium polyphosphate (APP), melamine polyphosphate (MPP), pyrophosphate (PyMP), or combinations thereof. In some embodiments, the IFR includes at least one of pentaerythritol (PER), a biomass lignin, or combinations thereof. In some embodiments, the IFR includes APP and PER. In some embodiments, the APP and PER have a mass ratio of 3:1.

In some embodiments, the ZIF has a size less than 1000 nm. In some embodiments, the ZIF has a size in a range between 100 nm to 1000 nm. In some embodiments, the ZIF has a size in a range between 200 nm to 300 nm. In some embodiments, the ZIF has a size in a range between 100 nm to 250 nm.

In some embodiments, the polymer is PP, the IFR includes APP and PER with a mass ratio of 3:1, and the ZIF includes ZIF-8 in an amount of 2 wt % of the flame-retardant composite. In some embodiments, the ZIF-8 has a size of 100 nm. In some embodiments, the ZIF-8 has a size of 250 nm. In some embodiments, the ZIF-8 has a size of 1000 nm.

In some embodiments, the ZIF has an amount between 1 wt % to 2 wt % of the flame-retardant composite. In some embodiments, the flame-retardant composite has a limiting oxygen index (LOI) greater than 28%. In some embodiments, the flame-retardant composite has a Standard for Safety of Flammability of Plastic Materials for Parts in Devices and Appliances (UL-94) rating of V-0.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1A illustrates heat release rate (HRR) for various composites of the present disclosure in comparison to neat polypropylene (PP) and polypropylene intumescent flame retardant (PP-IFR) composites.

FIG. 1B illustrates heat release rate (HRR) for PP-IFR composites with different zeolitic imidazolate frameworks (ZIFs).

FIG. 2A illustrates smoke production rate (SPR) for various composites of the present disclosure in comparison to neat PP and PP-IFR composites.

FIG. 2B illustrates smoke production rate (SPR) with different ZIFs.

FIG. 2C illustrates smoke production rate (SPR) for various composites of the present disclosure in comparison to PP-IFR composites.

FIG. 3A illustrates carbon monoxide production rate (COP) for various composites of the present disclosure in comparison to neat PP and PP-IFR composites.

FIG. 3B illustrates carbon monoxide production rate (COP) of PP-IFR composites with different ZIFs.

FIG. 3C illustrates carbon monoxide production rate (COP) for various composites of the present disclosure in comparison to PP-IFR composites.

FIG. 4A illustrates comparison results between different size ZIF-8 on heat release rate (HRR).

FIG. 4B illustrates comparison results between different size ZIF-8 on smoke production rate (SPR).

FIG. 4C illustrates comparison results between different size ZIF-8 on total heat release (THR).

FIG. 4D illustrates comparison results between different size ZIF-8 on carbon monoxide production rate (COP).

FIG. 5A illustrates comparison results between commercial ZIF-8 (ZIF-8-BASF), ZIF-8 synthesized at room temperature (ZIF-8-RT), and ZIF-8 synthesized at 40° C.(ZIF-8-40C) on heat release rate (HRR).

FIG. 5B illustrates comparison results between ZIF-8-BASF, ZIF-8-RT, and ZIF-8-40C on total heat release (THR).

FIG. 5C illustrates comparison results between ZIF-8-BASF, ZIF-8-RT, and ZIF-8-40C on smoke production rate (SPR).

FIG. 6A illustrates powder X-ray diffraction (PXRD) patterns of PP-IFR and PP-IFR-ZIF-8.

FIG. 6B illustrates the Raman spectra of the char residues obtained after cone calorimeter tests of PP-IFR and PP-IFR-ZIF-8.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

The automobile market demonstrates a high demand for polypropylene due to its advanced properties, such as its strength, stiffness, and chemical resistance. Currently, polypropylene is one of the lightest plastics for reducing weight in automobiles. In addition, there is high demand for polypropylene for use in building and construction. Currently, polypropylene accounts for more than one-fourth of the global construction composites due to its energy efficiency and weather resistance. Polypropylene is used for air and moister barrier membranes (e.g., siding) to decrease heat transfer, and as barrier films and sheets for resisting damage from hail or damage caused during high-wind conditions. However, polypropylene is highly flammable and releases toxic gases and smoke during combustion.

One approach to resolving these issues when using polypropylene is to utilize intumescent flame retardants (IFRs). IFRs are an environmentally-friendly alternative to halogen-based flame retardants. However, traditional IFRs cannot develop a thermally stable char protection layer to prevent heat transfer and mass transfer due to its poor dispersion efficiency, and thus they release more heat and toxic gases during combustion. As discussed above, commodity plastics and/or polymers are very flammable. Current commercial flame retardants for various polymers, such as polypropylene, are not sufficient enough for suppressing heat release and toxic gases during combustion. Additionally, current commercial IFRs have a low dispersion efficiency within the polymer matrix. As such, current commercial IFRs cannot form a compact and stable char residue during polymer combustion.

Therefore, a need exists for a fire-safe polymer composite that is capable for use in large-scale production, for example, in the automotive industry or in building and construction applications. Thus, the present disclosure seeks to address the aforementioned need by replacing small amounts of IFRs with different zeolitic imidazolate frameworks (ZIFs) to improve fire-related behaviors by forming a more compact and thermally stable char protection layer in the composite. This results in the reduction of toxicity released by, for example, smoke and carbon monoxide (CO), via a synergistic effect between IFRs and the ZIFs.

The present disclosure seeks to utilize the integration of metal-organic frameworks (MOFs), such as ZIFs with IFRs. As discussed in further detail herein, the integration of ZIFs with IFRs shows a promising strategy to develop well-dispersed and highly efficient flame-retardant polymer composites. For example, the composites of the present disclosure generally: (1) require small amounts of MOFs, while still providing significant improvements over conventional flame-retardant composites; (2) can produce well-dispersed microstructures within a polymer matrix; (3) provide high-performance and low-cost polymer composites; (4) can be manufactured in large-scale production; and (5) have reduced toxicity during combustion.

As discussed in further detail herein, the composites of the present disclosure promote a more stable char residue as physical barriers, and thus reduce the heat release rate and the smoke production rate during combustion. Furthermore, transition metals within the composites of the present disclosure can also catalyze the CO oxidation process efficiently. Aspects of the present disclosure focus on the manufacturing of composites, such as polypropylene composites, with much higher flame-retardant performance than composites currently available. The composites disclosed herein demonstrate strength in the char formation and overall reduction of smoke and CO production rates during composite combustion.

The advantages of the composites of the present disclosure are realized via the combining of conventional IFRs with MOFs (e.g., ZIFs). This combination improves dispersion efficiency due to the high compatibility with various polymer matrices. A synergistic effect between various MOFs (e.g., ZIFs) and IFRs further promotes a continuous thermal-stable char residue to reduce potential hazards and threats to human safety during polymer combustion. Furthermore, the composites of the present disclosure exhibit compact and stable char residue microstructures due to a char-promoting effect from MOFs fillers as opposed to current composites that have generally porous and brittle char residue.

By replacing some amounts of IFRs with MOFs, the structure of polymer composites can be maintained in a much more uniform and compact format. This structure promotes the formation of strong and stable char during the combustion process, therefore enforcing even higher performance of flame retardancy.

As disclosed herein, different polypropylene composites were synthesized, characterized, and fire tested. It was found that when adding 2 wt % ZIF-8, the peak heat release rate was decreased to 172.90 kW/m² compared with 298.30 kW/m² for conventional polypropylene IFR (PP-IFR) composite. In addition, ZIF-8 composites also show excellent smoke suppression. Furthermore, a reduction in total smoke released was observed from 2704.2 m²/m² to 1886.2 m²/m², and the peak smoke production rate decreased from 0.10 m²/s to 0.045 m²/s.

When replacing zinc with cobalt, it was found that ZIF-67 promoted the formation of more stable crosslinking components than ZIF-8, which leads to more compact and continuous char structures, as opposed to porous and brittle char residue found in compositions without ZIFs. CO production rates during the combustion were further decreased in ZIF-67 and ZnCoZIF composites when compared with ZIF-8 composites due to the catalytic oxidation process from cobalt. These ZIFs can be synthesized easily in large scale and are repeatable under room temperature. Furthermore, the polypropylene composites can be easily manufactured by using parallel twin-screw extruders, which are commonly used in the composite industry for producing polymer composites.

Furthermore, it is demonstrated herein that the particle size of the flame-retardant composites can affect performance. Various types and sizes of flame-retardant composites were tested. Three sizes of ZIF-8 (100 nm, 250 nm, and >1000 nm) were tested. The size was determined via scanning electron microscopy (SEM). The flame-retardant composites with ZIF having a size of 250 nm show the best flame-retardant properties, much better than that with a size greater than 1000 nm. Currently, commercialized ZIF-8 has a size that is larger than 1000 nm, indicating that the flame-retardant composites of the present disclosure exhibit greater performance compared to those currently available.

### Working Examples

Reference will now be made to more specific embodiments of the present disclosure and data that provides support for such embodiments. However, it should be noted that the disclosure below is for illustrative purposes only and is not intended to limit the scope of the claimed subject matter in any way.

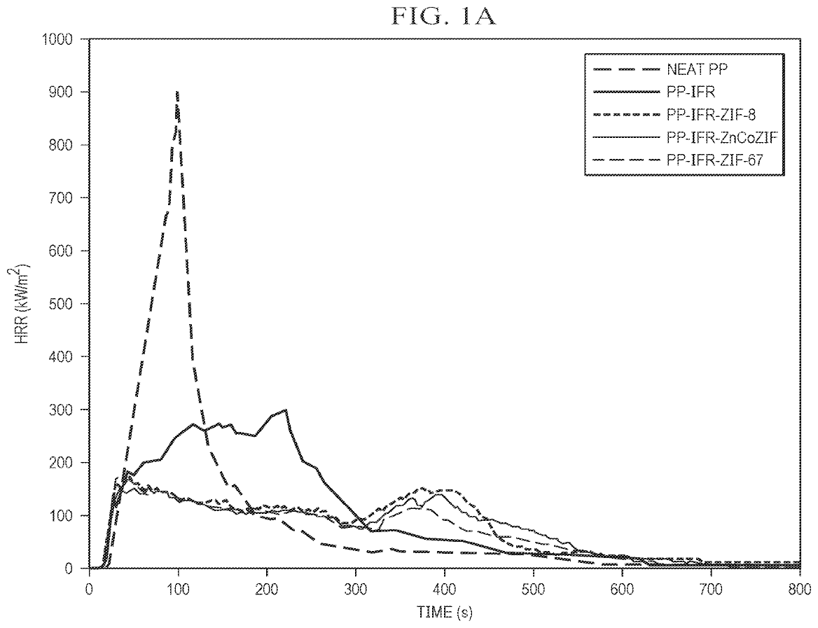

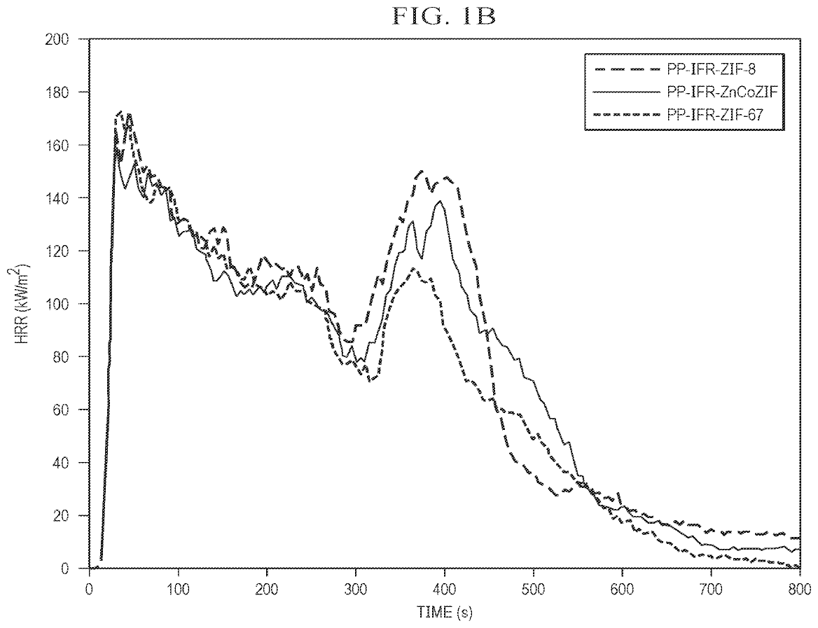

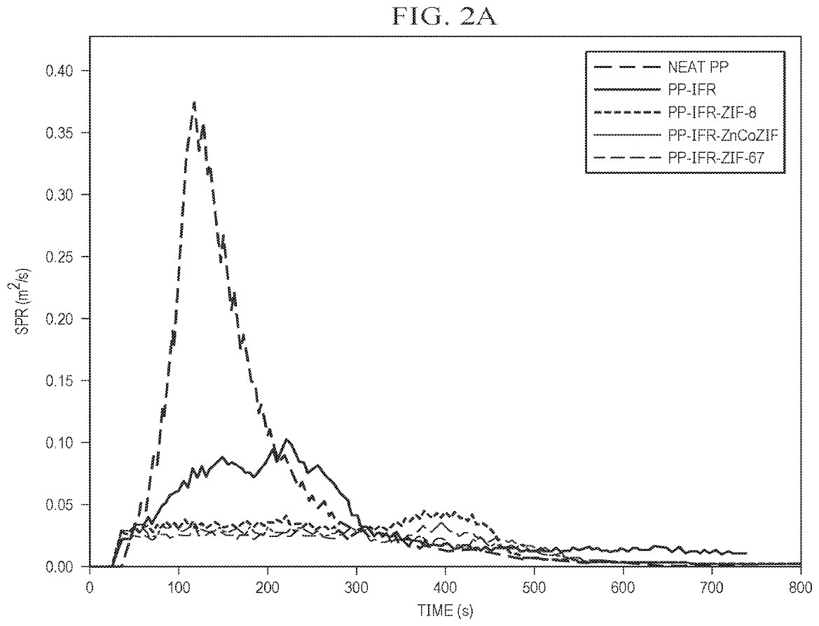

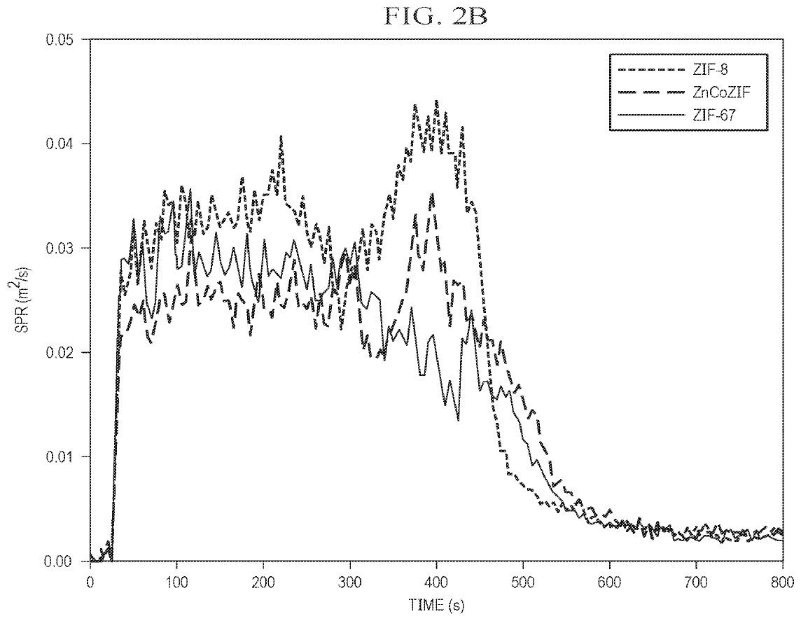

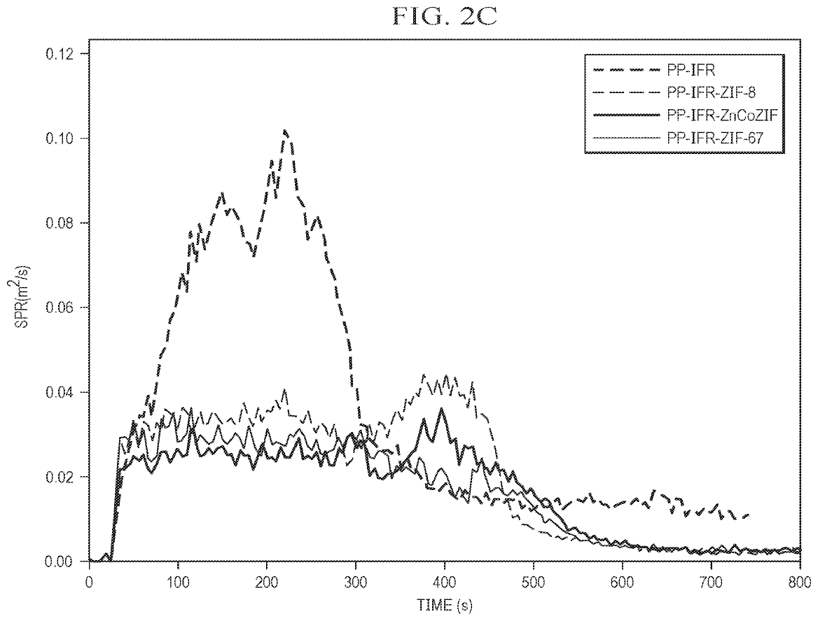

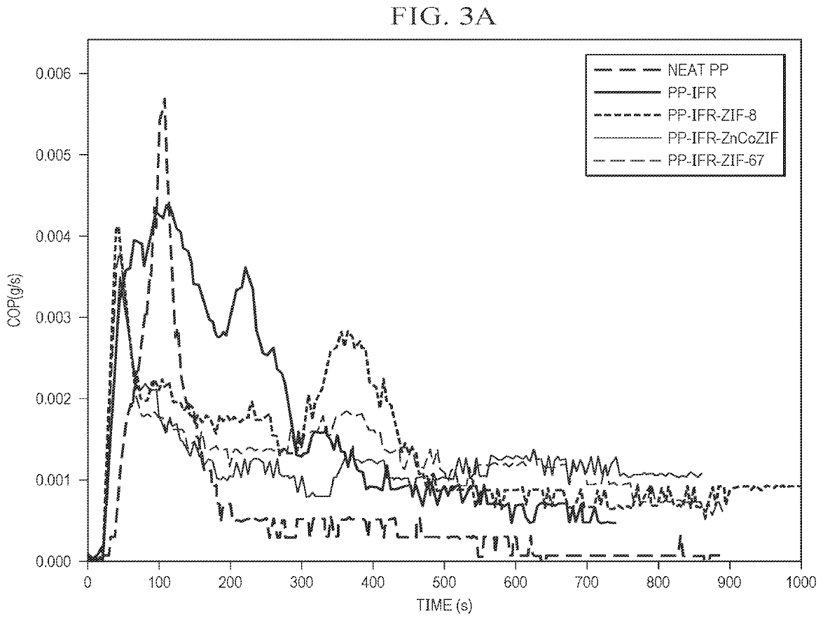

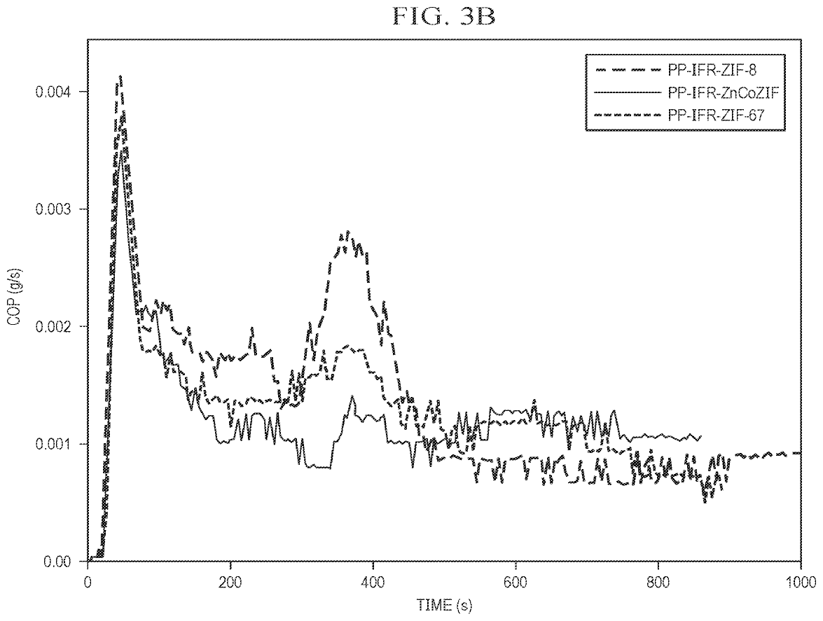

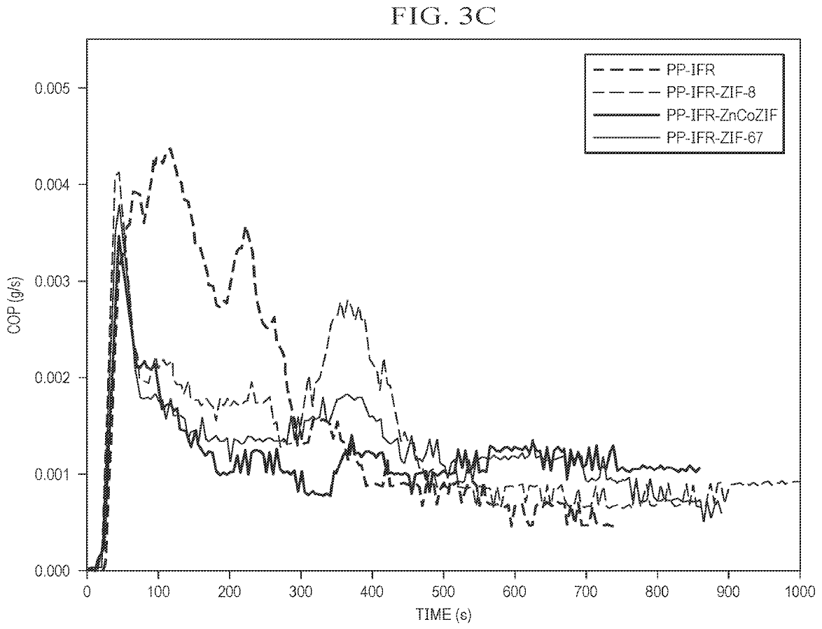

Halogen-free IFRs have been widely used in industries as a fire-safe polymeric composite. However, there are some challenges for IFRs, such as poor stability and low dispersion efficiency in the polymer matrix. A combination of conventional IFRs with ZIFs is demonstrated herein as a promising strategy to develop well-dispersed and highly efficient flame-retardant polypropylene (PP) composites. PP-IFR-ZIF polymeric composites are synthesized, characterized, and followed by manufacturing for fire testing. When adding 2 wt % ZIF-8, the peak heat release rate decreases to 172.90 kW/m² compared with 298.30 kW/m² for IFR-PP and 904.98 kW/m² for neat PP (FIG. 1A and FIG. 1B). Furthermore, the second heat release rate peak (char decomposition) is significantly delayed and suppressed compared with traditional IFRs. ZIF-8 composites also show excellent smoke suppression, with a reduction of total smoke release from 2704.2 m²/m² to 1886.2 m²/m², and peak smoke production rate decreasing from 0.10 m²/s to 0.045 m²/s (FIG. 2A, FIG. 2B, and FIG. 2C). This demonstrates that MOFs have an efficient synergy with IFRs for reducing smoke production. Additionally, CO production rates are also suppressed during the combustion (FIG. 3A, FIG. 3B, and FIG. 3C). FIG. 1A to FIG. 3C also show data for PP-IFR-ZnCOZIF and PP-IFR-ZIF-67.

The reasons for these improvements are ascribed to a synergistic effect between IFR and ZIF-8 on promoting cross-linking reaction in the condensed phase for a carbonaceous physical barrier. Different metal ions (e.g., ZIF-67) and bimetal ZIFs (e.g., ZnCoZIF) were also synthesized to investigate how metal ion compositions affect the fire safety performance of PP-IFR-ZIF composites. Interestingly, ZIF-67 promoted more stable crosslinking components than ZIF-8, which leads to more compact and continuous char structures. CO production rate during the combustion further decreases in ZIF-67 composites compared with ZIF-8 composites due to the catalytic oxidation process from the metal cobalt. Overall, with a small loading (e.g., 2%) of ZIFs in PP-IFR, the composites of the present disclosure can remarkably reduce the flammability and toxicity of burning polypropylene, including heat release rate, smoke production, and CO production rate. Therefore, the manufacturing of ZIFs with conventional IFRs provides a new platform on developing higher fire performance polypropylenes.

Fire test results. The flame retardancy of neat polymers, conventional polymer-IFR, and polymer-IFR-MOF composites were also investigated using limiting oxygen index (LOI) and vertical burning rating tests using the Standard for Safety of Flammability of Plastic Materials for Parts in Devices and Appliances (i.e., UL-94) to compare their relative flammability and provide a qualitative classification of the samples. Specifically, under the guidance of Standard Test Method for Measuring the Minimum Oxygen Concentration to Support Candle-Like Combustion of Plastics (Oxygen Index) (i.e., ASTM D2863), LOI test mainly focuses on measuring the minimum concentration of oxygen (volume based) to support flaming combustion. Under the guidance of the Standard Test Method for Measuring the Comparative Burning Characteristics of Solid Plastics in a Vertical Position (i.e., ASTM D3801), UL-94 testing is used to describe the response of solid polymers to heat and flame under a controlled condition (20 mm flame, 50 W).

Herein, the use PP as an example of polymer and ammonium polyphosphate (APP) and pentaerythritol (PER) with a mass ratio of 3:1 is considered as an example of a conventional IFR. 2 wt % of different MOFs, including three sizes of ZIF-8 (100 nm, 250 nm, and >1000 nm), ZnCoZIF, and ZIF-67 were added for comparison.

With the addition of 2 wt % different MOFs, all the samples can reach a V-O rating (i.e., burning stops within 10 sec on a vertical part allowing for drops of plastic that are not inflames) as shown in Table 1. A V-1 rating indicates burning stops within 30 sec on a vertical part allowing for drops of plastic that are not inflames. In addition, the LOI results with different ZIF-8 loading were also investigated and are shown in Table 2.

TABLE 1
UL-94 ratings of PP-IFR composite and
different PP-IFR-MOF composites.

| Sample | UL-94 Rating |
|---|---|
| PP-IFR only | V-1 |
| PP-IFR-ZIF-8 (>1000 nm) | V-0 |
| PP-IFR-ZIF-8 (~250 nm) | V-0 |
| PP-IFR-ZIF-8 (~100 nm) | V-0 |
| PP-IFR-ZnCoZIF | V-0 |
| PP-IFR-ZIF-67 | V-0 |

TABLE 2
LOI values of PP-IFR composite and PP-IFR-
ZIF-8 composites with different loading.

| Sample | LOI (%) |
|---|---|
| PP-IFR only | 26.7 |
| PP-IFR-ZIF-8 (1 wt %) | 29.1 |
| PP-IFR-ZIF-8 (2 wt %) | 31.2 |

Size effects on the reaction-to-fire properties. The particle size of MOFs can range from dozens of nanometers to several microns by controlling the reaction conditions. To investigate the feasibility of different sizes on the synergistic effects, three types of ZIF-8 were considered herein. It was found that all the three categories of PP-IFR-ZIF-8 composites have an excellent synergistic effect on heat, toxicity, and smoke suppressions compared to neat polymer and IFR only composites (FIG. 1A to FIG. 3C). Moreover, ZIF-8 with different sizes exhibited a slightly different synergistic performance, thus various manufacturing methods based on the available resources in the factory and required demands from the customers can be considered.

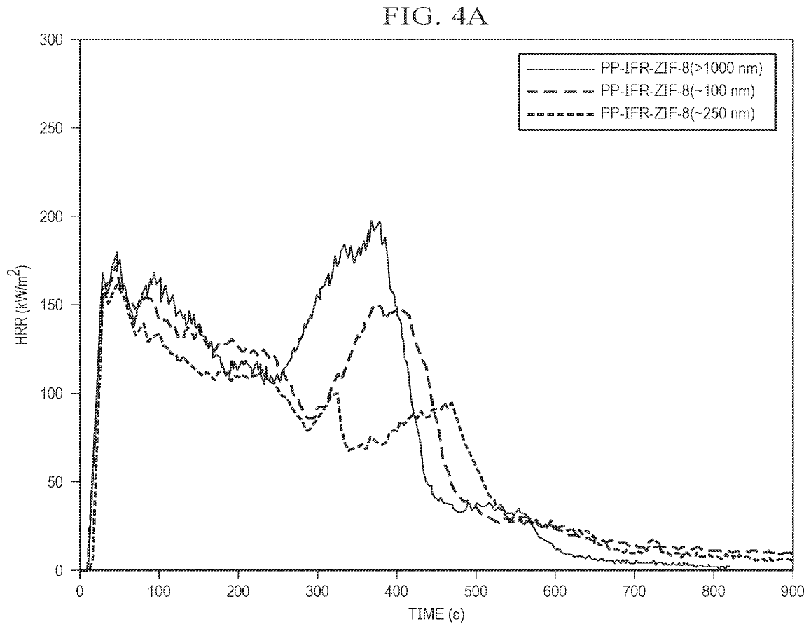

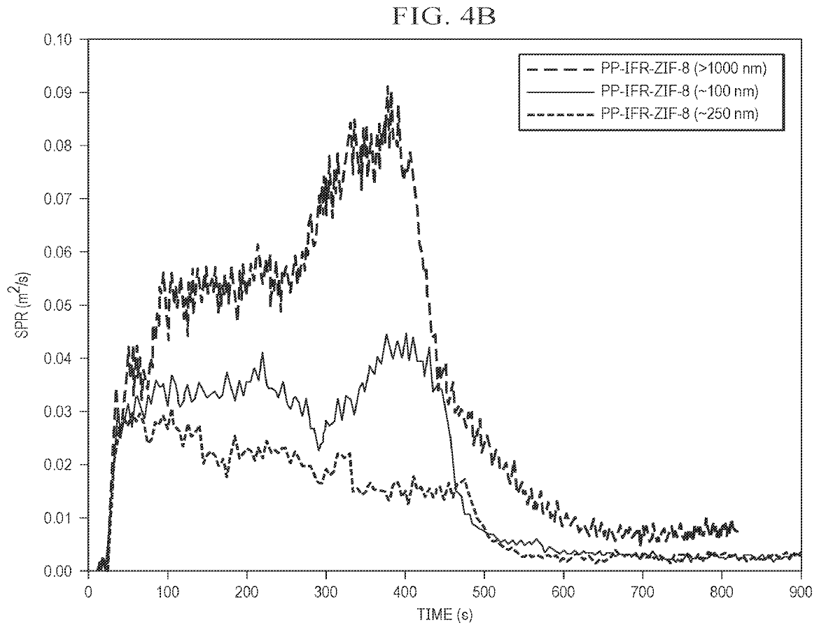

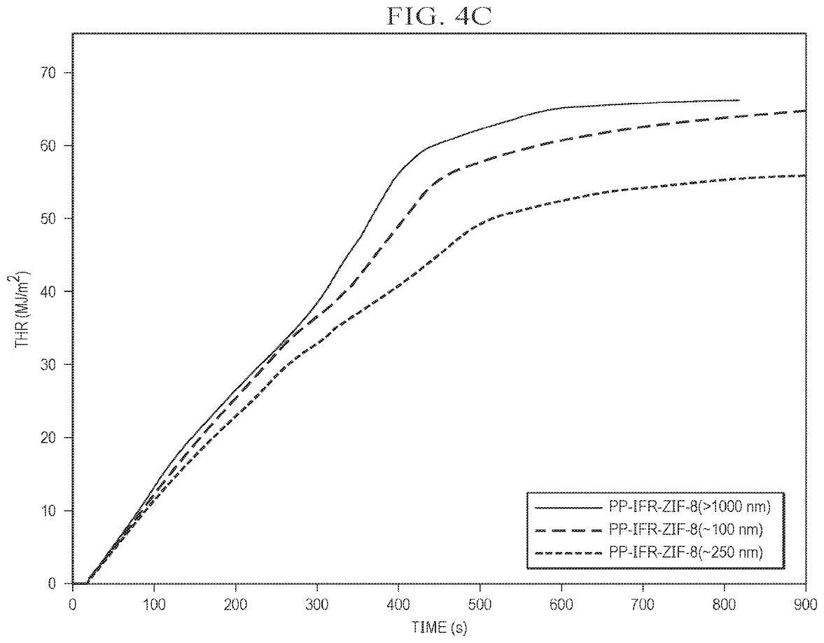

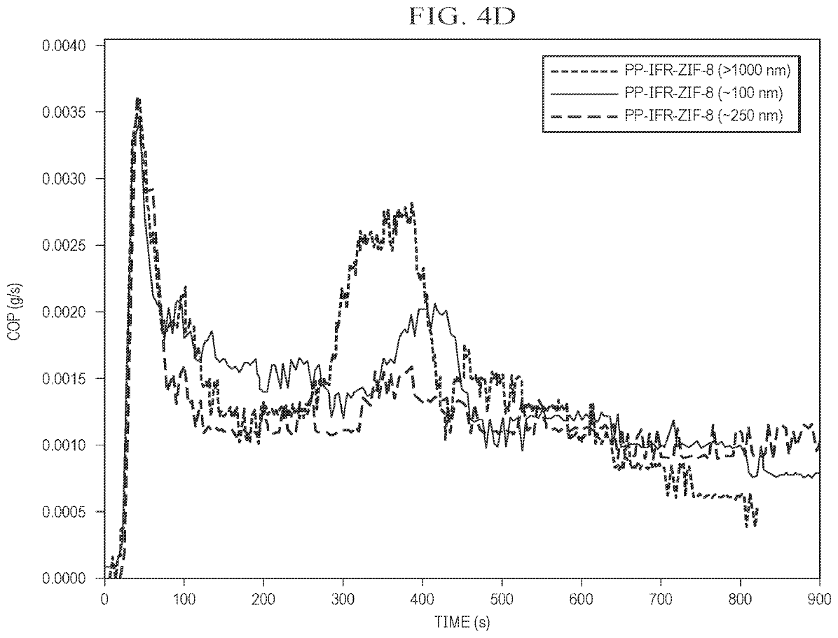

FIG. 4A to FIG. 4D illustrate comparison results between ZIF-8 with different sizes on the heat, toxicity, and smoke suppression. FIG. 4A shows heat release rate (HRR), FIG. 4B shows smoke production rate (SPR), FIG. 4C shows total heat release (THR), and FIG. 4D shows carbon monoxide production rate (COP).

Different manufacturing processes would have a different final product size distribution which influences the performance of flame retardant. To illustrate this, studies were conducted on lab-synthesized ZIF-8 and commercialized ZIF-8 from BASF (ZIF-8-BASF). The flame-retardant composites with ZIF-8 having a size of 250 nm show the best flame-retardant properties, much better than that with a size greater than 1000 nm. Currently, commercialized ZIF-8 (e.g., ZIF-8-BASF) has a size that is larger than 1000 nm due to aggregation, indicating that the flame-retardant composites of the present disclosure exhibit greater performance compared to those currently available.

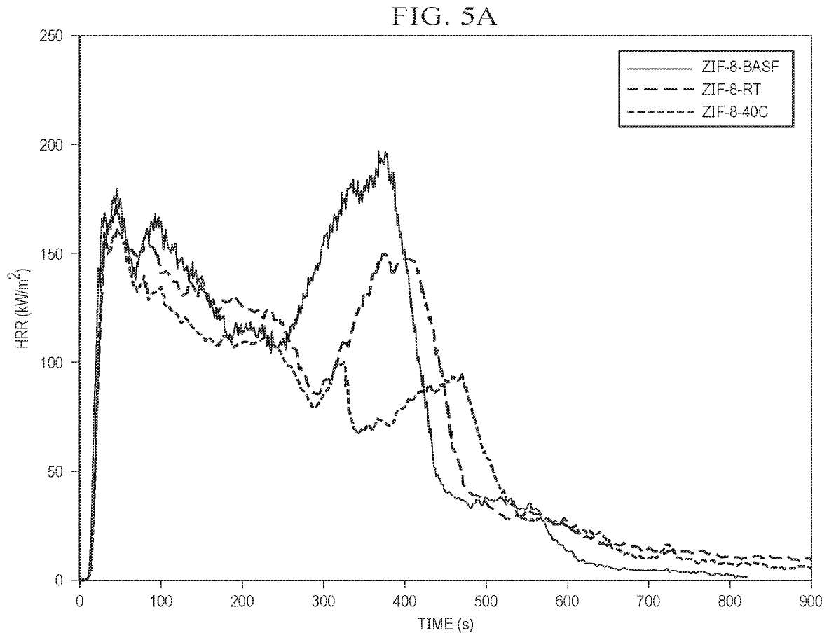

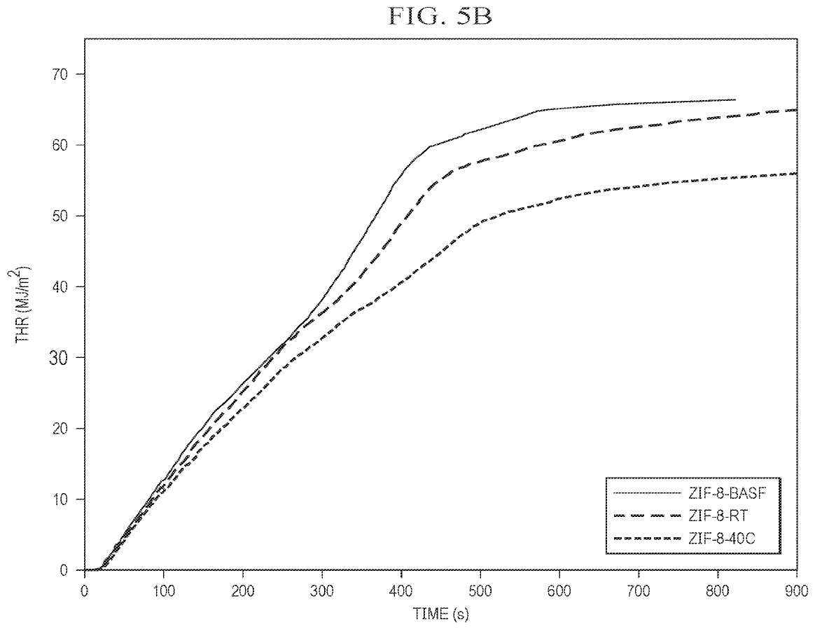

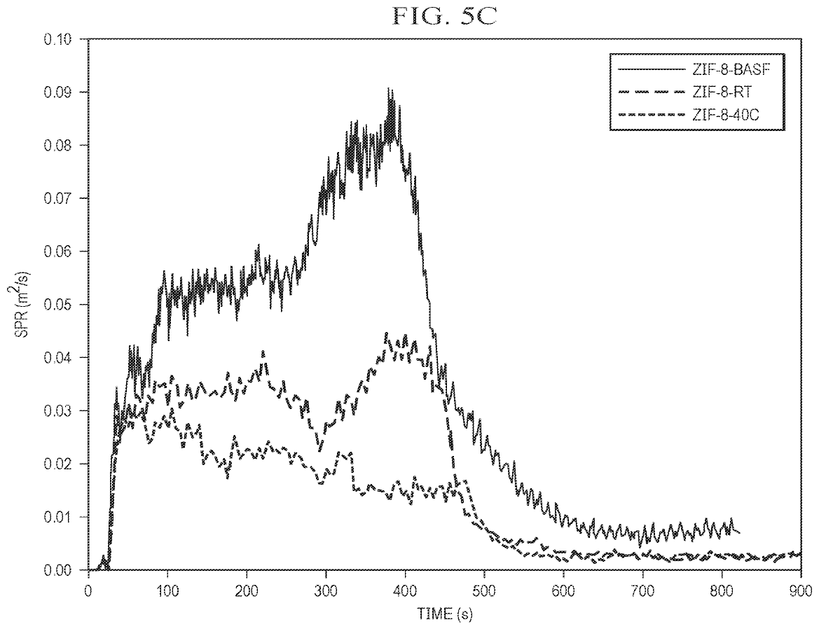

FIG. 5A to FIG. 5C illustrate comparison results between larger size commercial ZIF-8 (ZIF-8-BASF), ZIF-8 synthesized at room temperature (ZIF-8-RT), and ZIF-8 synthesized at 40° ° C.(ZIF-8-40C) on the heat release, total heat release, and smoke production rates. FIG. 5A shows heat release rate (HRR), FIG. 5B shows total heat release (THR), and FIG. 5C shows smoke production rate (SPR).

Comparison of carbonaceous residues. SEM images obtained from the sample PP-IFR at different magnifications show flaws and cracks that could be observed on the surface of the char. This may be the major reason for the relatively poor flame retardancy of PP-IFR. In contrast, SEM images show the morphology of the char residue of PP-IFR-ZIF-8 changed significantly, and it is more compact, continuous, and smooth. There are some folds on the surface, which could act as a skeleton to strengthen the surface layer.

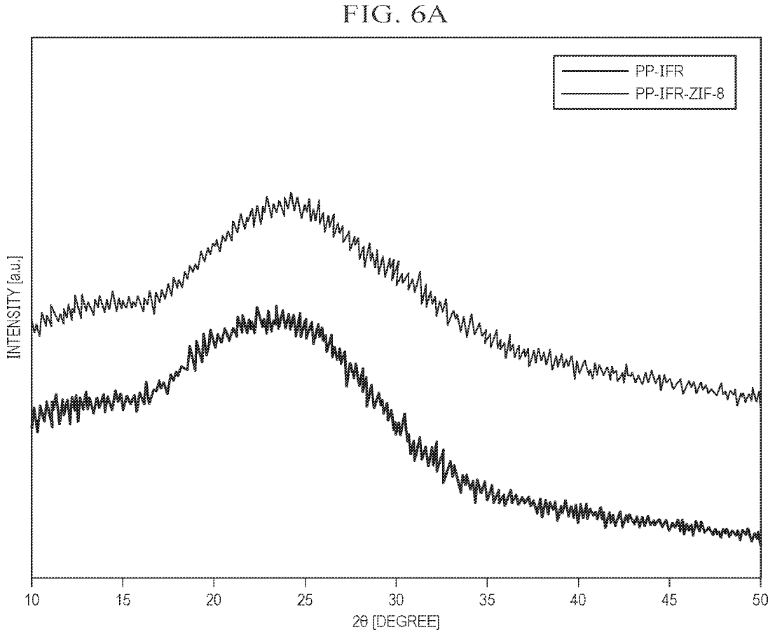

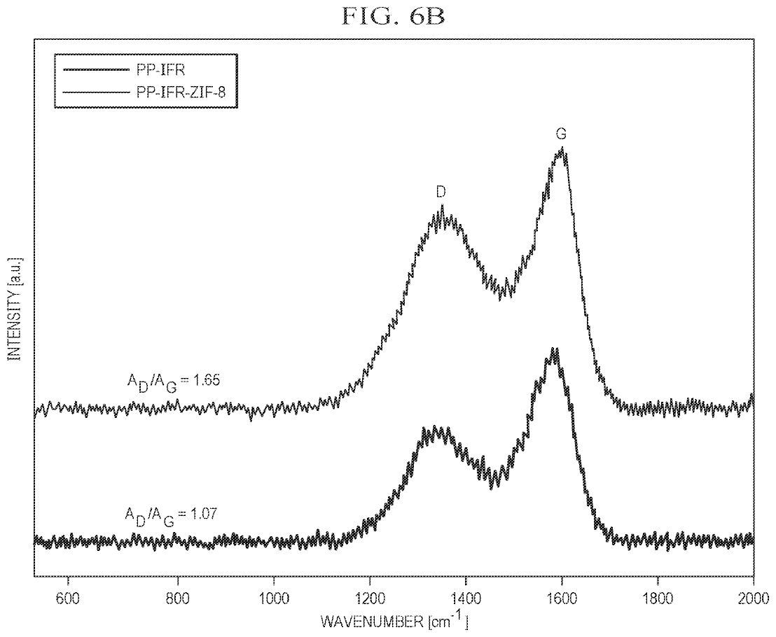

As shown in FIG. 6A, powder X-ray diffraction (PXRD) patterns of PP-IFR and PP-IFR-ZIF-8 exhibit a broad diffraction peak at 23°, suggesting the formation of graphitized char. Raman spectroscopy is a powerful tool to analyze carbonaceous materials due to its high sensitivity to the degree of structural disorder. FIG. 6B shows the Raman spectra of the char residues obtained after cone calorimeter tests. The spectra of the char residue of PP-IFR and PP-IFR-ZIF-8 exhibit two broad bands around 1350 cm⁻¹ (D peak) and 1590 cm⁻¹ (G peak). Essentially, the higher the ratio of AD/AG (band area ratio), the better structure the char is. The spectra from PP-IFR-ZIF-8 show that the intensity ratio of Ap/AG is greater than that of PP-IFR. Therefore, the size of carbonaceous microstructures from PP-IFR-ZIF-8 could be smaller than those from PP-IFR. Typically, a higher protective shield efficiency is related to the smaller sizes of carbonaceous microstructures.

In general, results indicate that the formulations for commodity plastics and/or polymers, such as polypropylene, polyethylene, high-density polyethylene, low-density polyethylene, polystyrene, polyvinyl chloride, and poly(methyl methacrylate), have demonstrated superior results when compared to other types of polymers. However, other polymers, for example, different commodity plastics and/or polymers are readily envisioned.

Although various embodiments of the present disclosure have been illustrated in the accompanying Drawings, and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

1. A flame-retardant composite comprising:
a polymer;
an intumescent flame retardant (IFR); and
a metal-organic framework (MOF).

2. The flame-retardant composite of claim 1, wherein the polymer is selected from the group consisting of polypropylene, polyethylene, high-density polyethylene, low-density polyethylene, polystyrene, polyvinyl chloride, poly(methyl methacrylate), a polyolefin, and combinations thereof.

3-5. (canceled)

6. The flame-retardant composite of claim 1, wherein the MOF is a zeolitic imidazolate framework (ZIF).

7. (canceled)

8. The flame-retardant composite of claim 6, wherein the ZIF is selected from the group consisting of ZIF-8, ZIF-67, ZIF-8 synthesized at room temperature (ZIF-8-RT), ZIF-8 synthesized at 40° ° C.(ZIF-8-40C), and combinations thereof.

9. The flame-retardant composite of claim 1, wherein the MOF is a bimetallic MOF.

10. The flame-retardant composite of claim 9, wherein the bimetallic MOF is a bimetal ZIF.

11. The flame-retardant composite of claim 10, wherein the bimetal ZIF comprises two metals each selected from the group consisting of transition metals, iron, zinc, cobalt, nickel, copper, and combinations thereof.

12. (canceled)

13. The flame-retardant composite of claim 10, wherein the bimetal ZIF is ZnCoZIF.

14. The flame-retardant composite of claim 1, wherein the IFR comprises at least one of an acid, a carbon agent, a blowing agent, or combinations thereof.

15. The flame-retardant composite of claim 1, wherein the IFR comprises at least one of ammonium polyphosphate (APP), melamine polyphosphate (MPP), pyrophosphate (PyMP), or combinations thereof.

16. The flame-retardant composite of claim 1, wherein the IFR comprises at least one of pentaerythritol (PER), a biomass lignin, or combinations thereof.

17. The flame-retardant composite of claim 1, wherein the IFR comprises APP and PER.

18. The flame-retardant composite of claim 17, wherein the APP and PER comprises a mass ratio of 3:1.

19-22. (canceled)

23. The flame-retardant composite of claim 1, wherein the polymer is PP, wherein the IFR comprises APP and PER with a mass ratio of 3:1, and wherein the MOF comprises ZIF-8 in an amount of 2 wt % of the flame-retardant composite.

24-27. (canceled)

28. The flame-retardant composite of claim 1, comprising a limiting oxygen index (LOI) greater than 28%.

29. The flame-retardant composite of claim 1, comprising a Standard for Safety of Flammability of Plastic Materials for Parts in Devices and Appliances (UL-94) rating of V-0.

30-53. (canceled)
